(19) United States
(12) Patent Application Publication
(10) Pub. No.: US 2013/0212137 A1
(43) Pub. Date: Aug. 15, 2013

(54) Tip Calculator

(71) Applicants: Philippe Guillaud, Culver City, CA (US); Cyril Lalo, Los Angeles, CA (US)

(72) Inventors: Philippe Guillaud, Culver City, CA (US); Cyril Lalo, Los Angeles, CA (US)

(21) Appl. No.: 13/397,602

(22) Filed: Feb. 15, 2012

(51) Int. Cl. G06F 3/00

(52) U.S. Cl. 708/144; 708/142

(57) ABSTRACT

An electronic tip calculator for providing an instant tip calculation to a user is disclosed. The electronic tip calculator comprises a touch keypad located on a front surface, a display screen located on the front surface and a power button located on the front surface. The touch keypad includes a plurality of touch buttons. The display screen is configured to display a tip amount and a total bill amount to the user and the power button is configured to activate the electronic tip calculator. The display screen allows the user to instantly retrieve the tip amount by navigating through the touch keypad. The touch keypad and the display screen are configured to provide a simple and convenient means of tip calculation to the user. The electronic tip calculator can be easily configured to calculate any tip rate as desired by the user.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This invention relates to electronic tip calculators, and more particularly to an improved electronic tip calculator capable of providing an instant tip solution to a user.

### DISCUSSION OF RELATED ART

Tips are monetary benefits provided as a gratuity to a person performing services in bars, hotels, spas, clubs, taxis, salons, parking garages etc. Tips are often calculated by people using guess work, printed tip sheets or tip calculators. These processes can be difficult and time consuming for many people. Often, these types of tip calculation will cause customers to under-tip, over-tip, or avoid tipping. Most of the tip calculators are bulky and inconvenient to carry. The main problem associated with the use of these calculators is that they cannot be configured easily to calculate any tip rate as required by the user. Currently, users have to manually calculate the tip rate by entering the bill amount in the calculator or calculate the tip amount with respect to default tip rates only.

U.S. Pat. Application. No. 20110073660 entitled to Lawyer on Mar. 31, 2011 discloses a transaction card with a three-dimensional tipping guide and techniques for using the card. This transaction card includes a base with a front card surface, a back card surface, and a first and a second set of indicators visible along the outer areas of the front and back card surfaces. At least one of the first and second sets of indicators represents a financial amount. The transaction card also includes a region configured to carry machine readable information. The card is configured to be rotated during usage. However, this transaction card cannot be configured to calculate any tip rate as desired by the user. Further, the card does not have the capability to provide an instant tip calculation at the touch of a finger.

U.S. Pat. No. 7,415,492 issued to Soliman on Aug. 19, 2008, describes a tip calculator and methods for using it to calculate tips with ease and without the requirement for knowledge of tip calculating formulas. The calculator is comprised of a base member having a face side, wherein the face side has at least one display screen having a main display area and a share display area, and three groupings of buttons. The first grouping of buttons includes whole numbers from 0 to 9, buttons designating mathematical functions, an on and off button, and a clear button for clearing of the main display area. The second grouping of buttons includes buttons designating tip amounts as percentages of the bill amount, and a button for designating the total amount. The third grouping of buttons is used to select the number of members in a group and includes a share button to obtain an individual's tip share. The first grouping of buttons is used to enter the bill amount; the second grouping of buttons is used to enter a choice of a tip amount as a percentage of the bill amount with the subsequent display of the tip amount on the main display area; and the third grouping of buttons is used to display the individual's share in the share display area. However, the tips calculator does not provide an instant means of tip calculation to the user. Further, the tip calculator is bulky and hence cannot be conveniently carried by the user.

U.S. Pat. No. 6, 076, 079 issued to Boston on Jun. 13, 2000, discloses an electronic calculating device for conveniently calculating a percentage of an amount. This device comprises a first side, a second side and a control mechanism on the first side with which the server or diner can use to input a bill amount. A control mechanism is positioned on the second side to calculate a percentage value of the bill amount. The second side includes additional buttons which allow the operator to select a predetermined percentage value, preferably fifteen or twenty percent. The operator may use a MORE button or a LESS button to increase or decrease, in single integer increments, the percentage value. A display is provided for displaying the percentage value or tip amount, as well as the total of the tip and the amount of the bill. However, the card does not include a customizable and programmable touch keypad.

Therefore, there is a need for a device that can offer an instant means of tip calculation to the user at the touch of a fingertip. Such a needed device would be easily configured to calculate any desired tip rate by the user. The calculator is capable of providing a customizable and programmable touch keypad. Further, the calculator is user-friendly and portable so that it can easily fit in a user's wallet. Such a calculator would require no extra network or system to operate and is ready to use upon delivery. The present embodiment accomplishes these objectives.

### SUMMARY OF THE DISCLOSURE

The present invention is an electronic tip calculator for providing an instant tip calculation to a user. The electronic tip calculator comprises a touch keypad located on a front surface, a display screen located on the front surface and a power button located on the front surface. The touch keypad includes a plurality of touch buttons. The display screen is configured to display a tip amount and a total bill amount to the user and the power button is configured to activate the electronic tip calculator. The touch keypad and the display screen are configured to provide a simple and convenient means of tip calculation to the user.

The electronic tip calculator is provided with a default tip rate of 18%. Each of the plurality of touch buttons of the touch keypad is capable of providing preset values of tip rates selected from a group consisting of: 5%, 10%, 15% and 20%. The electronic tip calculator may be easily configured to calculate any tip rate as desired by the user. The user may calculate the tip amount by entering a bill amount in the electronic tip calculator utilizing the plurality of touch buttons. The touch keypad is an integrated, unique, customizable and programmable smart phone-like touch keypad. The display screen is a high contrast LCD screen which allows the user to instantly retrieve the tip amount by navigating through the touch keypad.

The electronic tip calculator provides a convenient tip solution to the user simply with the touch of a fingertip. The electronic tip calculator is produced with customized artwork in a familiar credit card form factor and is portable. The electronic tip calculator requires no extra network or system to operate and is ready to use upon delivery. Due to its sleek compact card form factor, the electronic tip calculator does not require bulky packaging with expensive shipping which keeps costs down for corporations and in turn can reduce the user costs as well.

The present invention provides an improved tip calculator for providing an instant means of tip calculation to the user at the touch of the fingertip. Such a calculator can be easily configured to calculate any desired tip rate by the user. Further, the calculator is user-friendly and portable so that it can easily fit in a user's wallet. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a pictorial view of an electronic tip calculator;

FIG. 2 is an operational flow chart illustrating a method for calculating a tip amount and a total bill amount by a user utilizing an electronic tip calculator in a calculator mode; and

FIG. 3 is a flowchart illustrating a method for configuring a desired tip rate by a user utilizing the electronic tip calculator in a set up mode.

### DETAILED DESCRIPTION OF THE PREFERRED EMBODIMENT

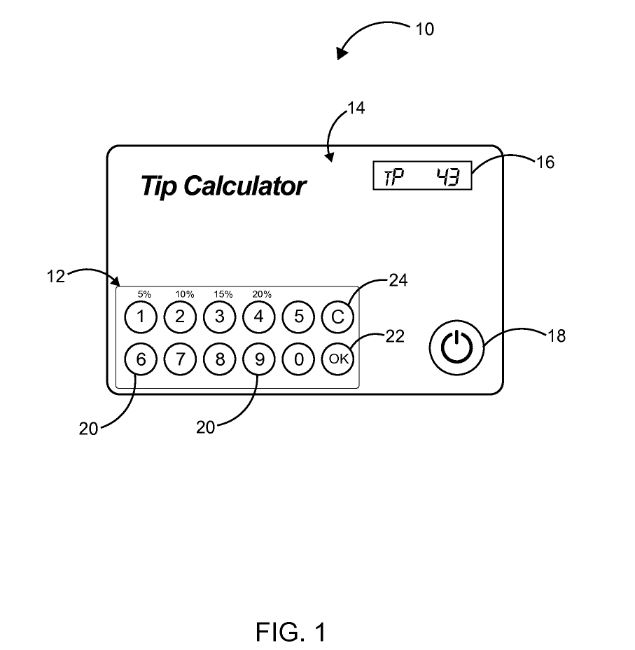

FIG. 1 is a pictorial view of an electronic tip calculator 10 for providing an instant tip calculation to a user (not shown). The electronic tip calculator 10 comprises a touch keypad 12 located on a front surface 14, a display screen 16 located on the front surface 14 and a power button 18 located on the front surface 14. The touch keypad 12 includes a plurality of touch buttons 20. The display screen 16 is configured to display a tip amount and a total bill amount to the user and the power button 18 is configured to activate the electronic tip calculator 10. The touch keypad 12 and the display screen 16 are configured to provide a simple and convenient means of tip calculation to the user.

The electronic tip calculator 10 is provided with a default tip rate of 18%. Each of the plurality of touch buttons 20 of the touch keypad 12 is capable of providing preset values of tip rates selected from a group consisting of: 5%, 10%, 15% and 20%. The electronic tip calculator 10 may be easily configured to calculate any tip rate as desired by the user. The user may calculate the tip amount by entering a bill amount in the electronic tip calculator 10 utilizing the plurality of touch buttons 20. The plurality of touch buttons 20 may be twelve in number. The touch keypad 12 is an integrated, unique, customizable and programmable smart phone-like touch keypad. The touch keypad 12 provides a familiar feel for the user and adds a level of interactivity between the user and the electronic tip calculator 10. The display screen 16 is a high contrast LCD screen which allows the user to instantly retrieve the tip amount by navigating through the touch keypad 12.

The electronic tip calculator 10 provides a convenient tip solution to the user simply with the touch of a fingertip. The electronic tip calculator 10 is produced with customized artwork in a familiar credit card form factor and is portable. The slender credit card form is appealing to the user with the display screen 16 and the touch keypad 12 all compacted to fit in a wallet. The electronic tip calculator 10 requires no extra network or system to operate and is ready to use upon delivery. Due to its sleek compact card form factor, the electronic tip calculator 10 does not require bulky packaging with expensive shipping which keeps costs down for corporations and in turn can reduce the user costs as well.

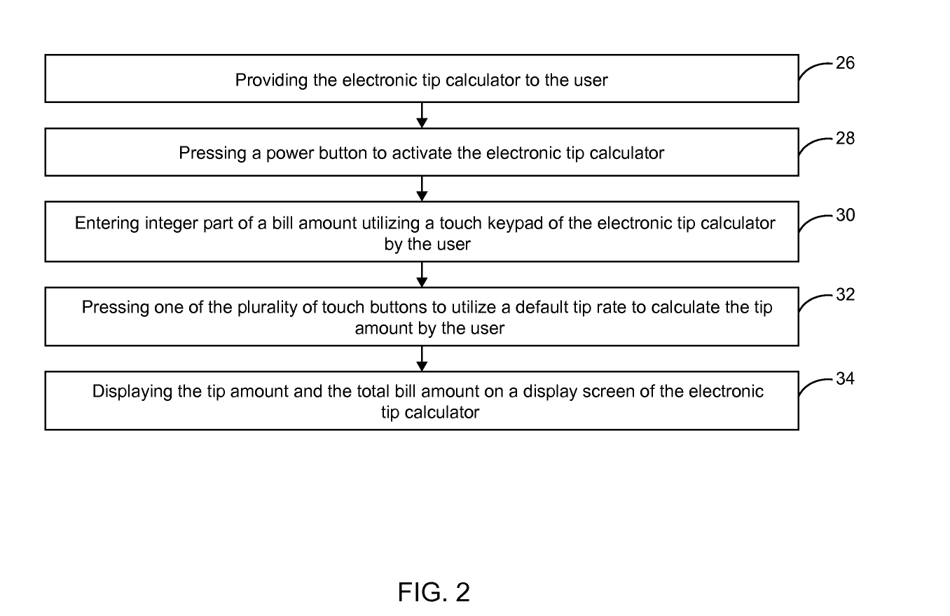

FIG. 2 is an operational flow chart illustrating a method for calculating a tip amount and a total bill amount by a user utilizing the electronic tip calculator 10 in a calculator mode. Initially, the electronic tip calculator is provided to the user as indicated at block 26. Then, a power button is pressed to activate the electronic tip calculator as shown in block 28. Integer part of a bill amount is entered utilizing a touch keypad of the electronic tip calculator by the user as indicated at block 30. As shown in block 32, one of the plurality of touch buttons is pressed to utilize a default tip rate to calculate the tip amount by the user. Finally, the tip amount and the total bill amount are displayed on a display screen of the electronic tip calculator as shown in block 34.

In the calculator mode, the user may press one of the plurality of touch buttons 20 to utilize a default tip rate to calculate the tip amount. The one of the plurality of touch buttons 20 may be an “OK” button 22. The electronic tip calculator 10 is provided with a default tip rate of 18%. The tip rate will be displayed on the display screen 16 as “rt” followed by the tip rate. In addition, the user may press at least one of the plurality of touch buttons 20 of the touch keypad 12 to utilize preset values of tip rates to calculate the tip amount by the user. The preset values of tip rates may be selected from a group consisting of: 5%, 10%, 15% and 20%. The user may revert to the default tip rate by pressing “C” button 24 and then pressing the “OK” button 22 to calculate the tip amount. The tip amount is calculated as tip amount=bill amount*tip rate/100. The total bill amount is calculated as total bill amount=bill amount+tip amount. The tip amount will be displayed on the display screen 16 as “tp” followed by the tip amount. The user may further press the “OK” button 22 to calculate the total bill amount. The total bill amount will then be displayed on the display screen 16 as “tl” followed by the total bill amount.

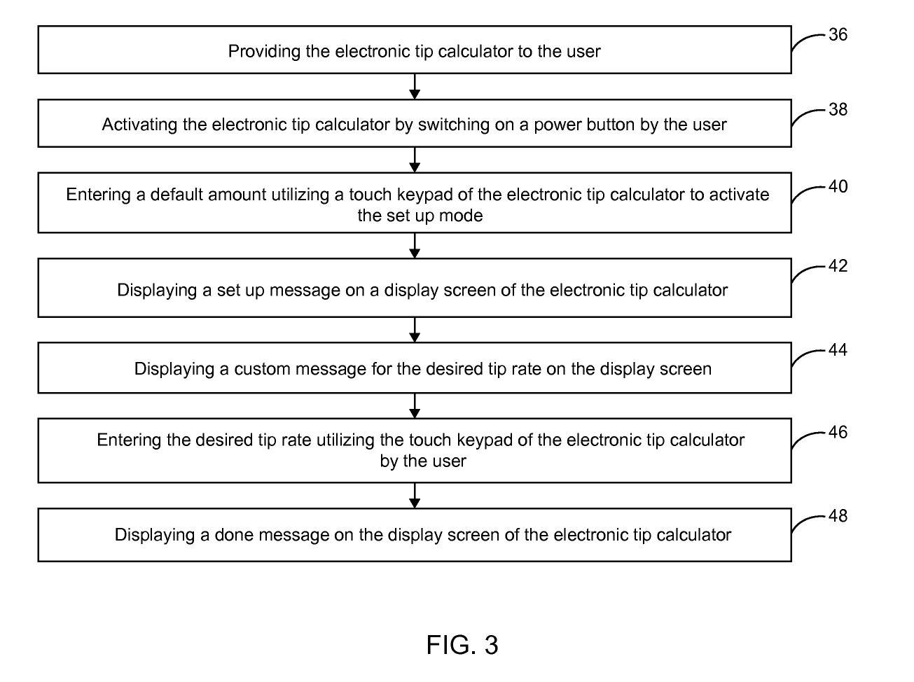

Referring to FIG. 3, a flow chart of a method for configuring a desired tip rate by a user utilizing the electronic tip calculator in a set up mode is illustrated. At first, the electronic tip calculator is provided to the user as shown in block 36. The electronic tip calculator is activated by switching on the power button by the user as indicated at block 38. A default amount is entered utilizing the touch keypad of the electronic tip calculator to activate the set up mode as shown in block 40. Then, a set up message is displayed on the display screen of the electronic tip calculator as indicated at block 42. A custom message for the desired tip rate is displayed on the display screen as shown in block 44. The desired tip rate is entered utilizing the touch keypad of the electronic tip calculator by the user as indicated at block 46. Finally, a done message is displayed on the display screen of the electronic tip calculator as shown in block 48.

The set up mode is used to configure the tip rate of the electronic tip calculator 10. In the set up mode, the plurality of buttons 20 do not have preset functions assigned, but can be used to enter the bill amount and to type in the desired tip rate by the user. The electronic tip calculator 10 may be easily configured to calculate the desired tip rate by the user. The electronic tip calculator 10 will display the set up message in the display screen 16. The user may enter the default amount “0000” utilizing the touch keypad 12 to activate the set up mode. The display screen 16 then displays a custom message for the desired tip rate. The custom message may be displayed as “rt” on the display screen 16. The custom message prompts the user to enter the desired tip rate utilizing the plurality of touch buttons 20. The desired tip rate may be selected between 0 and 99. The electronic tip calculator 10 will finally display a “Done” message on the display screen 16 when the new tip rate is validated. Once a new tip rate is set up, the value of the new tip rate will be recorded in the memory of the tip calculator 10 and will be used as the default tip rate for further use.

The electronic tip calculator 10 may be provided with optional features such as thermal transfer, laser printing which can be manufactured with custom graphics, or plain background utilizing a thermal card printer to print photos or other artwork on the electronic tip calculator 10. It is also possible to laser engrave or indent print information such as a serial number, a cardholder name or any text within specific areas of the electronic tip calculator 10. These features may be added at post manufacturing, by the end clients utilizing the necessary equipments such as thermal printer, laser engraver and indent machine. In addition, these features may also be added as an option by the manufacturer.

While a particular form of the invention has been illustrated and described, it will be apparent that various modifications can be made without departing from the spirit and scope of the invention. For example, the touch keypad 12, the display screen 16 and the power button 18 may be located anywhere on the front surface 14 so as to provide a better appearance to the electronic tip calculator 10. Accordingly, it is not intended that the invention be limited, except as by the appended claims.

What is claimed is:

1. An electronic tip calculator for providing an instant tip calculation to a user, the calculator comprising:
a touch keypad located on the front surface, the touch keypad includes a plurality of touch buttons;
a display screen located on the front surface, the display screen configured to display a tip amount and a total bill amount to the user; and
a power button located on the front surface, the power button configured to activate the electronic tip calculator;
whereby the touch keypad and the display screen are configured to provide a simple and convenient means of tip calculation to the user.

2. The electronic tip calculator of claim 1 wherein the electronic tip calculator is provided with a default tip rate of 18%.

3. The electronic tip calculator of claim 1 wherein each of the plurality of touch buttons is capable of providing preset values of tip rates selected from a group consisting of: 5%, 10%, 15% and 20%.

4. The electronic tip calculator of claim 1 wherein the electronic tip calculator may be easily configured to calculate any tip rate as desired by the user.

5. The electronic tip calculator of claim 1 wherein the user may calculate the tip amount by entering a bill amount in the electronic tip calculator utilizing the plurality of touch buttons.

6. The electronic tip calculator of claim 1 wherein the touch keypad is an integrated, unique, customizable and programmable smart phone-like touch keypad.

7. The electronic tip calculator of claim 1 wherein the display screen is a high contrast LCD screen.

8. The electronic tip calculator of claim 1 wherein the display screen allows the user to instantly retrieve the tip amount by navigating through the touch keypad.

9. The electronic tip calculator of claim 1 wherein the electronic tip calculator is produced with customized artwork in a familiar credit card form factor.

10. The electronic tip calculator of claim 1 wherein the electronic tip calculator is portable.

11. A method for calculating a tip amount and a total bill amount by a user utilizing an electronic tip calculator in a calculator mode, the method comprising the steps of:
a) providing the electronic tip calculator to the user;
b) pressing a power button to activate the electronic tip calculator;
c) entering integer part of a bill amount utilizing a touch keypad of the electronic tip calculator by the user, the touch keypad comprises a plurality of touch buttons;
d) pressing one of the plurality of touch buttons to utilize a default tip rate to calculate the tip amount by the user; and
e) displaying the tip amount and the total bill amount on a display screen of the electronic tip calculator;

12. The method of claim 11 wherein the default tip rate is 18%.

13. The method of claim 11 wherein step d) may further comprise:
d1) pressing at least one of the plurality of touch buttons of the touch keypad to utilize preset values of tip rates to calculate the tip amount by the user;

14. The method of claim 13 wherein the preset values of tip rates may be selected from a group consisting of: 5%, 10%, 15% and 20%.

15. The method of claim 11 wherein the electronic tip calculator is produced with customized artwork in a familiar credit card form factor.

16. A method for configuring a desired tip rate by a user utilizing the electronic tip calculator in a set up mode, the method comprising the steps of:
a) providing the electronic tip calculator to the user;
b) activating the electronic tip calculator by switching on a power button by the user;
c) entering a default amount utilizing a touch keypad of the electronic tip calculator to activate the set up mode;
d) displaying a set up message on a display screen of the electronic tip calculator;
e) displaying a custom message for the desired tip rate on the display screen;
f) entering the desired tip rate utilizing the touch keypad of the electronic tip calculator by the user; and
g) displaying a done message on the display screen of the electronic tip calculator;

17. The method of claim 16 wherein the electronic tip calculator may be easily configured to calculate the desired tip rate by the user.

18. The method of claim 16 wherein the desired tip rate may be selected between 0 and 99.

19. The method of claim 16 wherein the custom message for the desired tip rate prompts the user to enter the desired tip rate utilizing the plurality of touch buttons.

20. The method of claim 16 wherein the electronic tip calculator is produced with customized artwork in a familiar credit card form factor.
